(19) United States
(12) Patent Application Publication
(10) Pub. No.: US 2018/0293639 A1
(43) Pub. Date: Oct. 11, 2018

(54) Process and system in which the user can save and compare pairs of items between a single or multiple internet marketplaces

(71) Applicant: Sharon Moore, San Antonio, TN (US)

(72) Inventor: Sharon Moore, San Antonio, TN (US)

(21) Appl. No.: 15/479,376

(22) Filed: Apr. 5, 2017

(51) Int. Cl. G06Q 30/06; G06N 5/02

(52) U.S. Cl. CPC G06Q 30/0633; G06Q 30/0631; G06N 5/022

(57) ABSTRACT

This current invention is a system and application that is aimed to assist in making decisions when confronted with a large amount of options. The initial embodiment of the application is targeted towards simplifying decision making for online shopping. The process will consist of searching for items amongst online shops, adding possible items into a cart, then the app will present two of the items at a time and the user will select the preferred item. Every possible pairing of items in the cart will be presented, then a ranking is generated based on how frequently an item was selected as the preferred item. The application can be modified to address other situations in which many choices are possible and often difficult to distinguish which options are superior.

### CROSS-REFERENCES TO RELATED APPLICATIONS (IF ANY)

None

### BACKGROUND

### 1. Field of the Invention

The present invention relates to a process to record and optimize efficiency of comparing and selecting products through online marketplaces.

### 2. Description of Prior Art

Online shopping has become a normal activity, with some people using it as a primary means of shopping. Many market places include features to compare multiple products to assist in making a purchasing decision. For example, a customer could click a box beside 3 products and hit a “compare” option; then, the user would be taken to a page which shows each product's specifications side-by-side.

The app market is rapidly developing and changing, but at this point, the market has no product that is designed to take products from multiple sites and present them to the user two at a time for direct comparison in a binary fashion. The market place also has no user friendly tool designed to store researched links from multiple sites into a single file with easy access back to the original site.

There is still room for improvement in the art.

### SUMMARY OF THE INVENTION

The current invention is a system and application in which the user can compare and decide between purchasing options on a single internet shopping venue or between multiple internet shops, with each decision providing information allowing the app to create ranked lists of product feature preferences.

The system, in the preferred embodiment, would work like a computer application, smartphone application or a website application.

The process would be that a user would register and login. They would do their shopping search through the app and add possible selections to the “cart”. Filters can be established to select for or against certain characteristics. Alternatively, users would use the process via search engines or specific shopping venue cart as add-ons/extensions.

Once the cart is populated, the user would use the Comparison Interface. Two of the possible item selections will be presented. The user would pick one of the two. Side-by-side comparisons continue until the user has selected among all paired choices. The system tracks the number of times each item is selected. The most preferred items will have the highest selection count. Based upon the selection count, the system can then present the cart back in a user preferred product rack and stack. The system can also present the least preferred items.

It is recommended to the User to run the model until “End” to get to the final cart rack and stack. As an option, the user can choose to purchase any item at any point in the model run. The user will have an option to make product selections from the prioritized list; or, to use the Eliminate tool to independently remove single items from the cart and allow the model to automatically restack the cart; or, use the “Eliminate all items below’ tool to rerun the model using the user defined top items (ex: top 3, 5, 8, etc.)

The system will track data regarding how choices are made, and patterns of how characteristics are selected, for or against. As the system tracks how the choices are made and it can organize the items by predicted preference, before going through the comparison process.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 a system overview chart; and

FIG. 3 shows a cell phone screen.

### DESCRIPTION OF THE PREFERRED EMBODIMENT

There are a number of significant design features and improvements incorporated within the invention.

The current invention is a system and application that would allow consumers to compare items, products and services head-to-head, two at a time, while shopping online

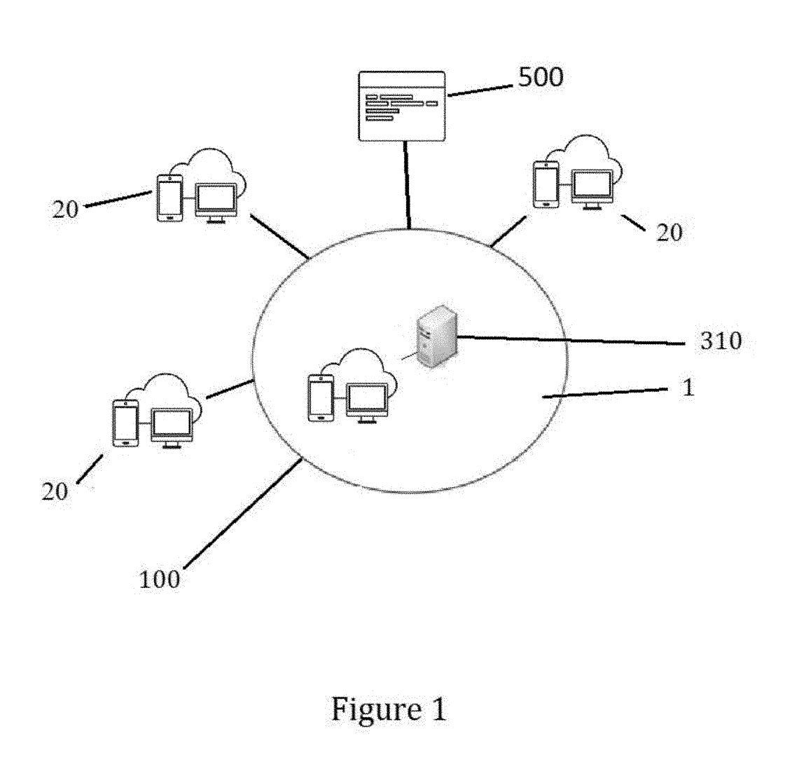

FIG. 1 displays the preferred embodiment of the system architecture 1 accessed through an Internet, Intranet and/or Wireless network 500. However, the system could be implemented on a device-to-device or client/server architecture as well. The system 1 is set to run on a computing device 20 or a website 500.

In FIG. 1, the system 1 is accessed from a user's computing device 20 through a web browser over HTTP and/or HTTPS protocols to a web site 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet or a wireless network. Computing devices like this are well known in the art and are not pertinent to the invention.

The system 1, data and processing code can reside in the non-transitory memory 310 of the one or more computing devices. The system 1 in the preferred embodiment would be written to act like a computer application, smart phone application (app) or website application where the different apps can communicate with each. The system 1 may work with a central server as shown in FIG. 1 or in parallel which each computing device 20 or smartphone communicating with others within the system 1. The system 1 can also work as a website application.

The system 1, data and processing code can reside in the non-transitory memory 310 of the one or more computing devices. The system 1 in the preferred embodiment would be written to act like a smart phone application (app) and could have a touch screen 100 or normal screen to allow a user to swipe the screen when making choices and decisions.

This current invention is a system 1 that can work as a computer application (app) that is aimed to simplify decision making when a large amount of options is possible, such as in an online marketplace. It is a system and computer application (app) in which the user adds items from a single or many different web sites, then the items are presented to the user two at a time and the user chooses the preferred item. The choices and selection are stored in a database memory 310.

After all possible pairings have been presented, a list is generated with the most selected items ranking highest. The system 1 can also generate a list of the least selected items. Each use will provide more information for the app, which will start to rank items before comparison, based on how certain features have been ranked.

The system 1 is a binary decision model (shopping tool) which enables the consumer to pare down a fully loaded-up shopping cart (wish list) into a manageable number of products and present them in a personally prioritized order. The system's shopping cart can be filled from a single to many on-line shopping venues. As the consumer discovers items of interest they simply add them to the system's database by clicking an ADD TO icon. Once the shopping cart is filled with the consumer's desired products, the consumer then clicks the RUN icon. During the model run, the system 1 presents every item in the cart in a paired decision layout.

For reference, the system 1 can save and store all of the information about the items in the wish list including their identification information, website and internet address. This allows the user quick reference to the items looked at as well as a reference database.

The user compares all the product information for the two items, selects the preferred item, then the model delivers the next of set paired choices. The model will run until all available paired choices are presented and selected. To obtain the prioritized list, the model must be fully run until the END.

The system 1 icon appears at which time the user can then switch back to the cart and review the items in their own prioritized list. The items most selected during the model run will surface to the top of the priorities/shopping cart. Although not likely, sometimes there will be a tie between two or more items, dependent upon the user's selections, but in this manner the shopper trims down their cart to a manageable few items most suited to meet the consumers' needs and price point.

It is recommended to the User to run the model until “End” to get to the final cart rack and stack. As an option, the user can choose to purchase any item at any point in the model run. The user will have an option to make product selections from the prioritized list; or, to use the Eliminate tool to independently remove single items from the cart and allow the model to automatically restack the cart; or, use the “Eliminate all items below’ tool, which can be set up as an icon, and rerun the model using the user defined top items (ex: top 3, 5, 8, etc.).

THE SYSTEM 1 allows the user to have multiple shopping carts. The user can name their shopping cart and save it for later reference (such as “TV” or “WINTER JACKET”, or even have a “MISCELLANEOUS” cart, composed of the shopper's entire online wish list). The shopper's carts can be filled and refilled multiple times, deleted, recreated, depending on the shopping experience of the day.”

An example shopping experience is as follows:

The shopping agenda for the day is to find the perfect rug at the right price to be used under the family dining room table. The shopper creates a THE SYSTEM 1 “Rug” cart and then uses major search engines and visits rug specific online stores and finds interesting rugs, then adds them to the system's cart. The system 1 allows the user to choose as many rugs as desired and then click RUN icon. The system 1 then asks the shopper to select their preferred rug between two rugs, etc. If available, the system will provide a link for the product. (Note: A user can also select the “least preferred” as part of the binary process and the items with the least number of selections would be the highest preferred product.)

To obtain a prioritized shopping list, the user must fully run the model until all paired choices are made and the END icon appears. As the model runs, the user must always select their preferred item between the two items presented. Sometimes this can be difficult because the user may like the two items seemingly the same. Still, the user must make their best choice and then be patient with the model, to allow it to fully run its course. The most selected items will surface to the top of the prioritized list. At the end of the model run the shopper clicks back on the cart and views their items in a priority order.

Sometimes a user may add an item to the cart based upon one aspect of the product criteria, such as style, color, or fabric. But, in the preferred embodiment, once they run the model, and thoroughly study all the product data, they realize adding the item to the cart was a mistake because other learned aspects of the product make it a non-purchase. For this reason, the system 1 allows the user to eliminate an item altogether. If an item is eliminated it falls into the ELIMINATED ITEMS basket. The model adjusts for the removal of the item (removes all associated paired choices) and then proceeds with the next decision. If the user decides at a later time to add an eliminated item back into the cart, or add new items into the cart, then the model will adjust for those added paired decisions. The user reruns the model until END icon appears and a prioritized list is created.

Finally, the system 1 uses links from online shopping venues and sometimes these links get broken or the product is no longer available. Therefore, items setting in the cart over a long period may no longer be available at the stored link.

Filters would be an options screen that allows users to set up search parameters. Set up to filter all searches this way or allow manual filtering during each search comparisons.

The cart holds all of the users saved selections in a database. This can be cleared at any time. More than one cart can be created by the system 1.

As stated above, the system 1 can be used for services as well as products and goods. The system 1 allows the ability to compare service providers . . . one to another. Is the same process but not a buying option, but rather a services comparison option. For example, it can be used for the searching for eye doctors that prescribe specialty contact lenses.

### Operation

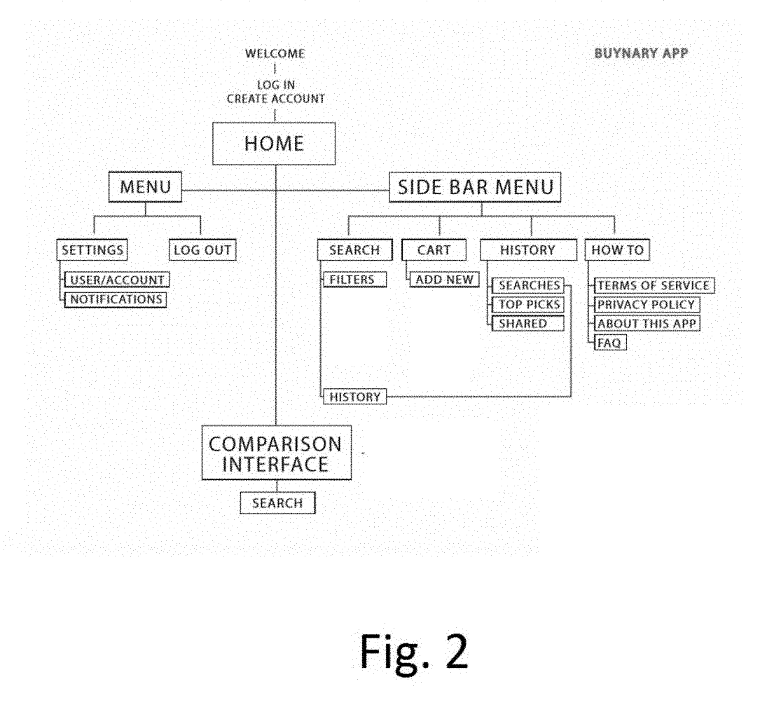

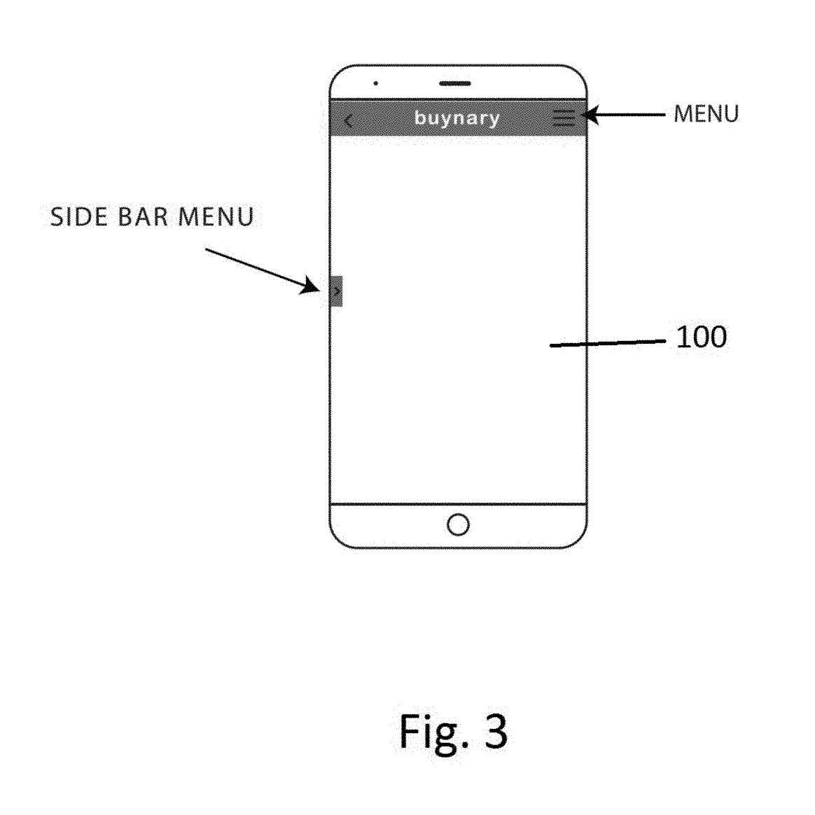

The system 1 setup is shown in the flowchart of FIG. 2. FIG. 3 shows a smart phone with a touch point screen 100 and the menu and side menu.

The user would log on or create an account on the system 1. After logging in, in the preferred embodiment, there will be a HOME screen.

From the HOME screen, the user can access the MENU, COMPARISON INTERFACE and the SIDE BAR MENU options.

The Menu has the SETTINGS and to LOGOUT functions. In Settings, the user can access Notifications and User/Account areas. User/Account allows the user to view and edit their personal information. The LOGOUT function will allow the user to log out.

The Comparison Interface will present the pairs of options from a cart. The user will select the preferred choice, and a new pair will be presented. This choice and the information about the choice will be stored in memory 310. When all possible pairs from a Cart have been presented, an “END” icon will appear. Clicking this option will generate a prioritized list of all the items in the specified Cart.

From the HOME screen, the user can access the SIDE BAR MENU. The Side Bar Menu links to SEARCH, CART, HISTORY, and HOW TO options.

Within SEARCH, the user will look for items that match the general criteria of the product they wish to purchase. The user can view the search HISTORY and also modify FILTERS. FILTERS will present options for search parameters that may be used on all searches or on individual searches.

Within CART, the user can click the ADD NEW icon, to add a search result into a general or specified cart. The user can use the REMOVE function to move an item to ELIMINATED ITEMS. The user can BRING BACK ITEM to move an item from Eliminated Items to the cart it had previously been in.

Within HISTORY, the user can view prior SEARCHES, TOP PICKS, and SHARED items.

Within HOW TO, the user can select to view TERMS OF SERVICE, PRIVACY POLICY, ABOUT THIS APP, and FAQ informational pages and functions.

The user can search for items, add them to a cart, then select preferences between all possible head-to-head pairings of items in the cart. Once complete, the app will generate a ranked list of most to least selected item in the cart. The list provides the user with a way to focus attention on which items are likely the most preferable. Items can be added or removed from cart and the operation may be repeated. Multiple carts may be created for different groupings, such as “umbrellas”, “cameras”, or “miscellaneous”.

The system 1 can be used for other decision making processes, such as where should the family take a vacation; what medicine best fits a patient's need; establishing priorities; determining how to best allocate the family budget, etc.

### Advantages

The system 1 enables the consumer to turn down the information firehose and focus on only one decision at a time. It also enables the shopper to easily track products between multiple internet sites, minimizing the time and frustration of moving back and forth between venues.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
placing a plurality of choices into an electric shopping cart;
making a selection from a number of choices;
comparing one choice against another choice;
choosing between the two;
adding up the selections from most selected to least selected;
presenting the shopping cart in a user prioritized order;
enabling the user to make a purchase decision at any point in the process;
enabling the user to make a purchase decision from the top listed items in a cart;
enabling the user to ‘Eliminate’ items individually from the shopping cart;
enabling the user to ‘Eliminate all items below’ the user's determined top product choices;
and rerun the model.

2. A system according to claim 1 where the choices have web links associated with them.

3. A system according to claim 1 where the choices are put into an electronic shopping cart.

4. A system according to claim 5 having the shopping cart filed with choices from a plurality of online shopping venues.

5. A system according to claim 1 having every choice compared to each other, calculate a score based on the result and use that score to generate a ranking.

6. A system according to claim 1 that is run as an application on one or more of a set of a smart phone, computer, desktop, laptop, tablet, smart phone or other general purpose computing device

7. A system according to claim 1 that is run on a website.

8. A system according to claim 1 where the choices are stored in a database.

9. A system according to claim 1 where a choice not chosen is moved to an elimination file.

10. A system according to claim 9 further comprising allow a choice not chosen may be removed from the elimination file.

11. A system according to claim 1 further comprising having an end icon appear when all the comparisons have been completed.

12. A system according to claim 1 enabling the user to eliminate all items below option and rerun the model.

13. A system according to claim 1 further comprising having filters that allows the setting up of search parameters.

14. A system comprising;
placing a plurality of choices into a database;
making a selection from a number of choices;
comparing one choice against another choice;
choosing between the two;
repeating until all of the choices have been compared to each other;
calculating a score based on the result; and
using that score to generate a ranking.

15. A system according to claim 14 where the choices have web links associated with them.

16. A system according to claim 14 that is run as an application on a smart phone.

17. A system according to claim 14 that is run on one or more of a set of computer, desktop, laptop, tablet, smart phone or computing device.

18. A system according to claim 14 that may be ran as an extension on a website.

19. A system according to claim 14 further comprising removing the choice not chosen.

20. A system according to claim 14 further comprising repeating the steps until a single choice is left
